(19) United States
(12) Patent Application Publication
(10) Pub. No.: US 2026/0099028 A1
(43) Pub. Date: Apr. 9, 2026

(54) Lens Driving Device

(71) Applicant: AAC Microtech (Changzhou) Co., Ltd., Changzhou City (CN)

(72) Inventors: Bo Xiao, Changzhou (CN); Tong Zhang, Changzhou (CN); Ronglin Linghu, Changzhou (CN); Wei Song, Changzhou (CN)

(21) Appl. No.: 19/001,535

(22) Filed: Dec. 25, 2024

Related U.S. Application Data
(63) Continuation of application No. PCT/CN2024/123625, filed on Oct. 9, 2024.

(51) Int. Cl. G02B 7/08; G02B 27/64

(52) U.S. Cl. CPC G02B 7/08; G02B 27/646

(57) ABSTRACT

A lens driving device is disclosed. The lens driving device includes a fixation holder, an optical image stabilization holder, and an elastic support connecting the two holders and supporting the optical image stabilization holder to move relative to the fixation holder. The elastic support includes a metal support and a flexible circuit board. The metal support includes four first elastic arms, and each includes two portions extending along a direction of an optical axis, one portion extending along a first direction, and another portion extending along a second direction. The flexible circuit board includes two second elastic arms, and each is at least partially fixed to the corresponding first elastic arm and includes four corresponding portions respectively facing the four portions of the corresponding first elastic arm. The lens driving device improves the reliability and the optical image stabilization effect.

### FIELD OF THE PRESENT DISCLOSURE

The present disclosure relates to the optical imaging field, in particular to a lens driving device.

### DESCRIPTION OF THE RELATED ART

In order to achieve a clear image, an optical imaging lens usually needs a focusing movement and an optical image stabilization movement.

A lens driving device in the related art includes a fixation holder, an optical image stabilization holder for the optical image stabilization movement relative to the fixation holder, and a focusing unit for the focusing movement relative to the optical image stabilization holder. The focusing unit is elastically supported on the optical image stabilization holder through an upper plate spring and a bottom plate spring. The optical image stabilization holder is elastically supported on the fixation holder through suspension wires at four corners.

However, since the suspension wire has a filamentary structure, its own structural strength is limited. As a result, the suspension wires cannot withstand the entire weight of the optical image stabilization holder and the focusing unit and are easily damaged when falling; furthermore, the suspension wires are easily fatigued and damaged when in a constant optical image stabilization movement; besides, the suspension wires cannot withstand a far optical image stabilization movement and limit the optical image stabilization movement in a small range. So that, the reliability of the lens driving device in the related art is low, and the optical image stabilization effect thereof is also poor.

Thus, it is necessary to provide a novel lens driving device to solve the problems.

### SUMMARY

An objective of the present disclosure is to overcome the above problems and provide a lens driving device which improves the reliability and the optical image stabilization effect.

In order to achieve the objective mentioned above, the present disclosure discloses a lens driving device including a fixation holder, an optical image stabilization holder, a first elastic support connecting the fixation holder and the optical image stabilization holder and supporting the optical image stabilization holder to move relative to the fixation holder, a focusing unit including a lens with an optical axis and a barrel for holding the lens, a second elastic support connecting the optical image stabilization holder and the barrel and supporting the barrel to move relative to the optical image stabilization holder, a first driving unit driving the barrel to move relative to the optical image stabilization holder along a direction of the optical axis, a second driving unit driving the optical image stabilization holder to move relative to the fixation holder along a first direction perpendicular to the optical axis, and a third driving unit driving the optical image stabilization holder to move relative to the fixation holder along a second direction perpendicular to the optical axis and the first direction. The first elastic support includes a metal support and a flexible circuit board at least partially fixed to the metal support. The metal support includes two first fixing parts respectively arranged on two opposite sides of the optical image stabilization holder and fixed to the fixation holder, two second fixing parts respectively arranged on another two opposite sides of the optical image stabilization holder and fixed to the optical image stabilization holder, and four first elastic arms respectively connected between every adjacent first fixing part and second fixing part. Four first gaps respectively separate every two adjacent first elastic arms. The flexible circuit board includes a third fixing part arranged on one of the two opposite sides of the optical image stabilization holder and fixed to the fixation holder, two fourth fixing parts respectively arranged on the another two opposite sides of the optical image stabilization holder and fixed to the optical image stabilization holder, and two second elastic arms respectively connected between every adjacent third fixing part and fourth fixing part. A second gap separates the two second elastic arms. Each second elastic arm is at least partially fixed to the corresponding first elastic arm. Each first elastic arm includes a first portion extending along the direction of the optical axis from the corresponding first fixing part, a second portion extending along the first direction from the first portion, a third portion extending along the second direction from the second portion, and a fourth portion extending along the direction of the optical axis from the third portion and connected to the corresponding second fixing part. Each second elastic arm includes a fifth portion extending along the direction of the optical axis from the third fixing part and facing the first portion of the corresponding first elastic arm, a sixth portion extending along the first direction from the fifth portion and facing the second portion of the corresponding first elastic arm, a seventh portion extending along the second direction from the sixth portion and facing the third portion of the corresponding first elastic arm, and an eighth portion extending along the direction of the optical axis from the seventh portion and facing the fourth portion of the corresponding first elastic arm, the eighth portion connected to the corresponding fourth fixing part.

As an improvement, each fifth portion is arranged on an outer side of the corresponding first portion away from the optical axis, each sixth portion is arranged on an outer side of the corresponding second portion away from the optical axis, each seventh portion is arranged on an outer side of the corresponding third portion away from the optical axis, each eighth portion is arranged on an outer side of the corresponding fourth portion away from the optical axis.

As an improvement, any adjacent first fixing part and second fixing part are arranged on the same side of the second portion and the third portion of the corresponding first elastic arm connected therebetween along the direction of the optical axis.

As an improvement, each second fixing part is separated by a third gap into two portions.

As an improvement, an amount of the first driving units is two, and the two first driving units are respectively arranged at two opposite corners of the optical image stabilization holder. Each first driving unit includes a magnetic circuit system fixed to the optical image stabilization holder and a focusing coil fixed to the barrel. The magnetic circuit system includes a magnetic frame and a magnetic member disposed in the magnetic frame. The magnetic frame includes a top wall and a bottom wall opposite to each other along the direction of the optical axis, and a side wall connecting the top wall and the bottom wall. The magnetic member is sandwiched between the top wall and the bottom wall. The focusing coil is disposed in the magnetic frame and sleeved on the magnetic member. The side wall is provided with two notches respectively arranged on two sides of the focusing coil. The barrel extends two supporting arms to the focusing coil for clamping the focusing coil. The two supporting arms respectively enter the magnetic frame through the two notches of the side wall and clamp the focusing coil.

As an improvement, observing along the direction of the optical axis, the focusing coil and the magnetic member have a matching contour shape. The magnetic member includes a first focusing magnet fixed to the top wall, a second focusing magnet fixed to the bottom wall, and a yoke sandwiched between the first focusing magnet and the second focusing magnet. The first focusing magnet and the second focusing magnet are magnetized in opposite directions along the direction of the optical axis.

As an improvement, an amount of the second driving units is two, and the two second driving units are respectively arranged at another two opposite corners of the optical image stabilization holder. Each second driving unit includes a first optical image stabilization magnet fixed to the fixation holder and a first optical image stabilization coil fixed to the optical image stabilization holder. An amount of the third driving units is two, and the two third driving units are respectively arranged at the another two opposite corners of the optical image stabilization holder. Each third driving unit includes a second optical image stabilization magnet fixed to the fixation holder and a second optical image stabilization coil fixed to the optical image stabilization holder.

As an improvement, the second elastic support includes a first plate spring and a second plate spring respectively arranged on two opposite sides of the barrel along the direction of the optical axis.

In the lens driving device according to the present disclosure, the first elastic support includes the metal support and the flexible circuit board at least partially fixed to the metal support. The metal support includes four first elastic arms, and each first elastic arm includes the first and fourth portions extending along the direction of the optical axis, the second portion extending along the first direction, and the third portion extending along the second direction. The flexible circuit board includes two second elastic arms, and each second elastic arm is at least partially fixed to the corresponding first elastic arm and includes the fifth through eighth portions respectively facing the first through fourth portions of the corresponding first elastic arm. Thus, the first elastic support has a three-dimensional structure for elastically supporting the optical image stabilization holder, compared with the suspension wires, on one hand, the reliability of elastically supporting the optical image stabilization holder is improved, especially in situations of falling and fatigue usage; on the other hand, the optical image stabilization holder can move for the optical image stabilization movement in a larger range, the optical image stabilization effect is improved. In addition, the first elastic support can also be used as a power transmission medium.

### BRIEF DESCRIPTION OF THE DRAWINGS

In order to more clearly illustrate the technical solutions in embodiments of the present disclosure, the accompanying drawings used in the description of the embodiments will be briefly introduced below. It is apparent that, the accompanying drawings in the following description are only some embodiments of the present disclosure, and other drawings can be obtained by those of ordinary skill in the art based on the accompanying drawings without creative efforts, wherein:

FIG. 1 is an exploded view of a lens driving device of the present disclosure.

FIG. 2 is an isometric view of the lens driving device of the present disclosure, removing a shell.

FIG. 3 is an isometric view of an assembly of a base, an optical image stabilization holder, and a first elastic support of the lens driving device of the present disclosure.

FIG. 4 is an exploded view of the first elastic support of the lens driving device of the present disclosure.

### DETAILED DESCRIPTION OF THE EMBODIMENTS

The technical solutions in embodiments of the present disclosure will be described clearly and completely below with reference to the accompanying drawings in the embodiments of the present disclosure. It is apparent that, the described embodiments are merely some of rather than all of the embodiments of the present disclosure. All other embodiments acquired by those of ordinary skill in the art without creative efforts based on the embodiments of the present disclosure shall fall within the protection scope of the present disclosure.

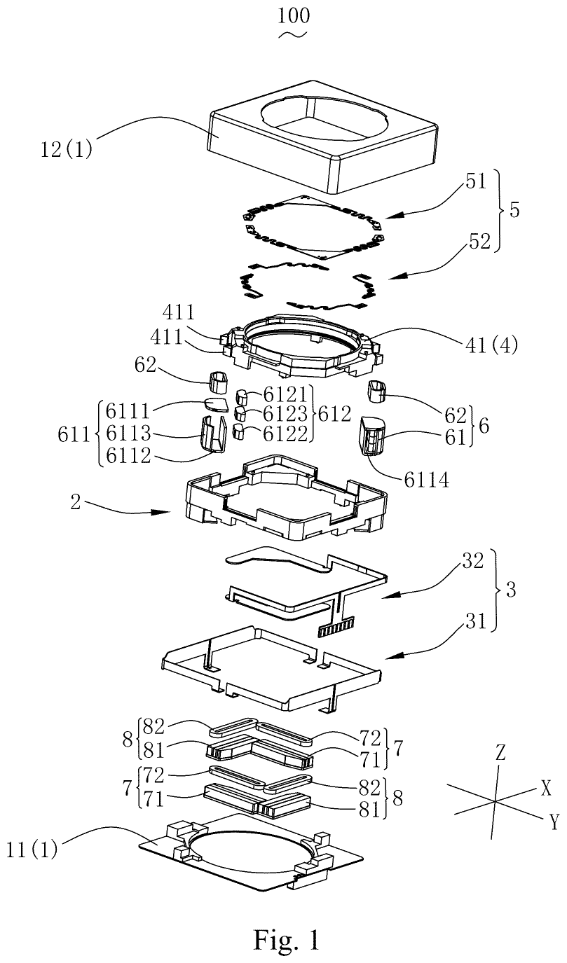

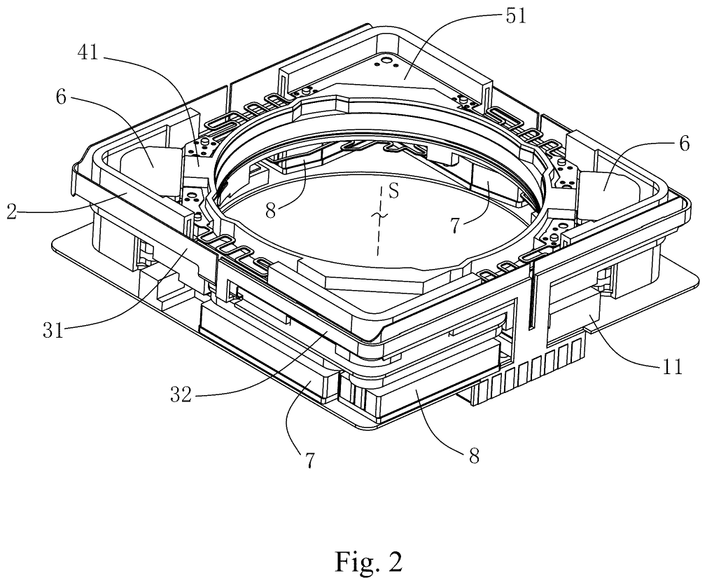

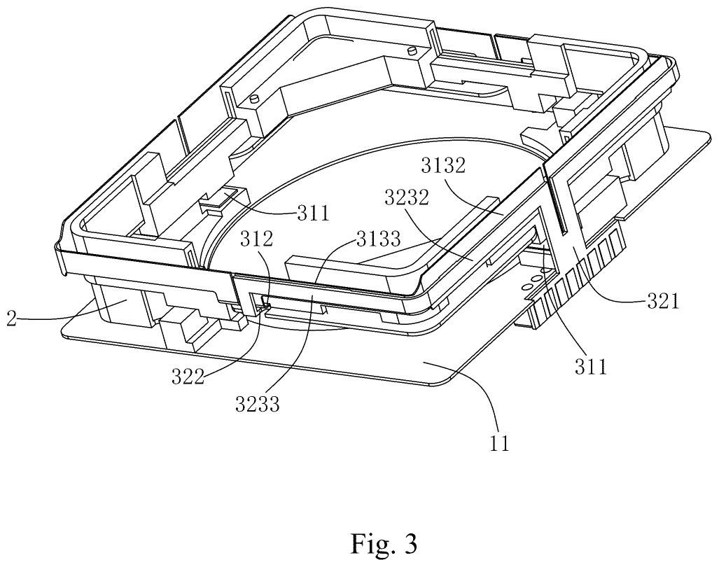

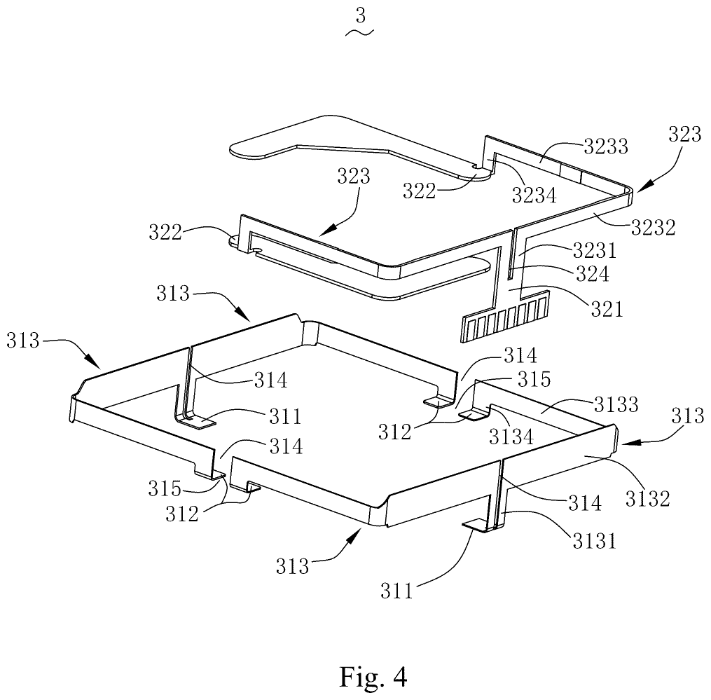

Referring to FIGS. 1-4, the present disclosure discloses a lens driving device 100 including a fixation holder 1, an optical image stabilization holder 2, a first elastic support 3, a focusing unit 4, a second elastic support 5, a first driving unit 6, a second driving unit 7, and a third driving unit 8.

In this embodiment, the fixation holder 1 includes a base 11 and a shell 12 engaged with the base 11. Optionally, the fixation holder 1 may also be provided in other ways, further may include more or fewer parts.

The first elastic support 3 connects the fixation holder 1 and the optical image stabilization holder 2 and supports the optical image stabilization holder 2 to move relative to the fixation holder 1.

The focusing unit 4 includes a lens with an optical axis S and a barrel 41 for holding the lens.

The second elastic support 5 connects the optical image stabilization holder 2 and the barrel 41 and supports the barrel 41 to move relative to the optical image stabilization holder 2. The second elastic support 5 may include a first plate spring 51 and a second plate spring 52 respectively arranged on two opposite sides of the barrel 41 along a direction Z of the optical axis S. Optionally, the second elastic support 5 may also be provided in other ways, as long as it is possible to support the barrel 41 to move relative to the optical image stabilization holder 2.

The first driving unit 6 drives the barrel 41 to move relative to the optical image stabilization holder 2 along the direction Z of the optical axis S.

The second driving unit 7 drives the optical image stabilization holder 2 to move relative to the fixation holder 1 along a first direction X perpendicular to the optical axis S.

The third driving unit 8 drives the optical image stabilization holder 2 to move relative to the fixation holder 1 along a second direction Y perpendicular to the optical axis S and the first direction X.

The first elastic support 3 includes a metal support 31 and a flexible circuit board 32 at least partially fixed to the metal support 31.

The metal support 31 includes two first fixing parts 311 respectively arranged on two opposite sides of the optical image stabilization holder 2 and fixed to the fixation holder 1 (base 11), two second fixing parts 312 respectively arranged on another two opposite sides of the optical image stabilization holder 2 and fixed to the optical image stabilization holder 2, and four first elastic arms 313 respectively connected between every adjacent first fixing part 311 and second fixing part 312. Four first gaps 314 respectively separate every two adjacent first elastic arms 313.

The flexible circuit board 32 includes a third fixing part 321 arranged on one of the two opposite sides of the optical image stabilization holder 2 and fixed to the fixation holder 1 (base 11), two fourth fixing parts 322 respectively arranged on the another two opposite sides of the optical image stabilization holder 2 and fixed to the optical image stabilization holder 2, and two second elastic arms 323 respectively connected between every adjacent third fixing part 321 and fourth fixing part 322. A second gap 324 separates the two second elastic arms 323. Each second elastic arm 323 is at least partially fixed to the corresponding first elastic arm 313.

Each first elastic arm 313 includes a first portion 3131 extending along the direction Z of the optical axis S from the corresponding first fixing part 311, a second portion 3132 extending along the first direction X from the first portion 3131, a third portion 3133 extending along the second direction Y from the second portion 3132, and a fourth portion 3134 extending along the direction Z of the optical axis S from the third portion 3133 and connected to the corresponding second fixing part 312.

Each second elastic arm 323 includes a fifth portion 3231 extending along the direction Z of the optical axis S from the third fixing part 321 and facing the first portion 3131 of the corresponding first elastic arm 313, a sixth portion 3232 extending along the first direction X from the fifth portion 3231 and facing the second portion 3132 of the corresponding first elastic arm 313, a seventh portion 3233 extending along the second direction Y from the sixth portion 3232 and facing the third portion 3133 of the corresponding first elastic arm 313, and an eighth portion 3234 extending along the direction Z of the optical axis S from the seventh portion 3233 and facing the fourth portion 3134 of the corresponding first elastic arm 313, the eighth portion 3234 connected to the corresponding fourth fixing part 322.

Each fifth portion 3231 is arranged on an outer side of the corresponding first portion 3131 away from the optical axis S, each sixth portion 3232 is arranged on an outer side of the corresponding second portion 3132 away from the optical axis S, each seventh portion 3233 is arranged on an outer side of the corresponding third portion 3133 away from the optical axis S, each eighth portion 3234 is arranged on an outer side of the corresponding fourth portion 3134 away from the optical axis S. Any adjacent first fixing part 311 and second fixing part 312 are arranged on the same side of the second portion 3132 and the third portion 3133 of the corresponding first elastic arm 313 connected therebetween along the direction Z of the optical axis S.

Each second fixing part 312 is separated by a third gap 315 into two portions, so as to separate the metal support 31 into two pieces through the communicated first gaps 314 and third gaps 315 for easily and respectively adjusting positions of the two pieces when installing the metal support 31.

An amount of the first driving units 6 is two, and the two first driving units 6 are respectively arranged at two opposite corners of the optical image stabilization holder 2. Each first driving unit 6 includes a magnetic circuit system 61 fixed to the optical image stabilization holder 2 and a focusing coil 62 fixed to the barrel 41. The first driving unit 6 may also be provided in other ways, not limited to the electromagnetic way.

The magnetic circuit system 61 includes a magnetic frame 611 and a magnetic member 612 disposed in the magnetic frame 611. The magnetic frame 611 includes a top wall 6111 and a bottom wall 6112 opposite to each other along the direction Z of the optical axis S, and a side wall 6113 connecting the top wall 6111 and the bottom wall 6112. The magnetic member 612 is sandwiched between the top wall 6111 and the bottom wall 6112. The focusing coil 62 is disposed in the magnetic frame 611 and sleeved on the magnetic member 612. The side wall 6113 is provided with two notches 6114 respectively arranged on two sides of the focusing coil 62. The barrel 41 extends two supporting arms 411 to the focusing coil 62 for clamping the focusing coil 62. The two supporting arms 411 respectively enter the magnetic frame 611 through the two notches 6114 of the side wall 6113 and clamp the focusing coil 62. Observing along the direction Z of the optical axis S, the focusing coil 62 and the magnetic member 612 have a matching contour shape. The magnetic member 612 includes a first focusing magnet 6121 fixed to the top wall 6111, a second focusing magnet 6122 fixed to the bottom wall 6112, and a yoke 6123 sandwiched between the first focusing magnet 6121 and the second focusing magnet 6122. The first focusing magnet 6121 and the second focusing magnet 6122 are magnetized in opposite directions along the direction Z of the optical axis S.

An amount of the second driving units 7 is two, and the two second driving units 7 are respectively arranged at another two opposite corners of the optical image stabilization holder 2. Each second driving unit 7 includes a first optical image stabilization magnet 71 fixed to the fixation holder 1 (base 11) and a first optical image stabilization coil 72 fixed to the optical image stabilization holder 2. An amount of the third driving units 8 is two, and the two third driving units 8 are respectively arranged at the another two opposite corners of the optical image stabilization holder 2. Each third driving unit 8 includes a second optical image stabilization magnet 81 fixed to the fixation holder 1 (base 11) and a second optical image stabilization coil 82 fixed to the optical image stabilization holder 2. The second driving unit 7 and the third driving unit 8 may also be provided in other ways, not limited to the electromagnetic way.

In the lens driving device 100 according to the present disclosure, the first elastic support 3 includes the metal support 31 and the flexible circuit board 32 at least partially fixed to the metal support 31. The metal support 31 includes four first elastic arms 313, and each first elastic arm 313 includes the first and fourth portions extending along the direction Z of the optical axis S, the second portion extending along the first direction X, and the third portion extending along the second direction Y. The flexible circuit board 32 includes two second elastic arms 323, and each second elastic arm 323 is at least partially fixed to the corresponding first elastic arm 313 and includes the fifth through eighth portions respectively facing the first through fourth portions of the corresponding first elastic arm 313. Thus, the first elastic support 3 has a three-dimensional structure for elastically supporting the optical image stabilization holder 2, compared with the suspension wires, on one hand, the reliability of elastically supporting the optical image stabilization holder 2 is improved, especially in situations of falling and fatigue usage; on the other hand, the optical image stabilization holder 2 can move for the optical image stabilization movement in a larger range, the optical image stabilization effect is improved. In addition, the first elastic support 3 can also be used as a power transmission medium.

The above are only embodiments of the present disclosure. It should be pointed out that those of ordinary skill in the art may also make improvements without departing from the ideas of the present disclosure, all of which fall within the protection scope of the present disclosure.

What is claimed is:

1. A lens driving device, comprising:
a fixation holder;
an optical image stabilization holder;
a first elastic support, connecting the fixation holder and the optical image stabilization holder and supporting the optical image stabilization holder to move relative to the fixation holder;
a focusing unit, comprising a lens with an optical axis and a barrel for holding the lens;
a second elastic support, connecting the optical image stabilization holder and the barrel and supporting the barrel to move relative to the optical image stabilization holder;
a first driving unit, driving the barrel to move relative to the optical image stabilization holder along a direction of the optical axis;
a second driving unit, driving the optical image stabilization holder to move relative to the fixation holder along a first direction perpendicular to the optical axis; and
a third driving unit, driving the optical image stabilization holder to move relative to the fixation holder along a second direction perpendicular to the optical axis and the first direction,
wherein the first elastic support comprises a metal support and a flexible circuit board at least partially fixed to the metal support; the metal support comprises two first fixing parts respectively arranged on two opposite sides of the optical image stabilization holder and fixed to the fixation holder, two second fixing parts respectively arranged on another two opposite sides of the optical image stabilization holder and fixed to the optical image stabilization holder, and four first elastic arms respectively connected between every adjacent first fixing part and second fixing part; four first gaps respectively separate every two adjacent first elastic arms; the flexible circuit board comprises a third fixing part arranged on one of the two opposite sides of the optical image stabilization holder and fixed to the fixation holder, two fourth fixing parts respectively arranged on the another two opposite sides of the optical image stabilization holder and fixed to the optical image stabilization holder, and two second elastic arms respectively connected between every adjacent third fixing part and fourth fixing part; a second gap separates the two second elastic arms;
each second elastic arm is at least partially fixed to the corresponding first elastic arm; each first elastic arm comprises a first portion extending along the direction of the optical axis from the corresponding first fixing part, a second portion extending along the first direction from the first portion, a third portion extending along the second direction from the second portion, and a fourth portion extending along the direction of the optical axis from the third portion and connected to the corresponding second fixing part; each second elastic arm comprises a fifth portion extending along the direction of the optical axis from the third fixing part and facing the first portion of the corresponding first elastic arm, a sixth portion extending along the first direction from the fifth portion and facing the second portion of the corresponding first elastic arm, a seventh portion extending along the second direction from the sixth portion and facing the third portion of the corresponding first elastic arm, and an eighth portion extending along the direction of the optical axis from the seventh portion and facing the fourth portion of the corresponding first elastic arm, the eighth portion connected to the corresponding fourth fixing part.

2. The lens driving device as described in claim 1, wherein each fifth portion is arranged on an outer side of the corresponding first portion away from the optical axis, each sixth portion is arranged on an outer side of the corresponding second portion away from the optical axis, each seventh portion is arranged on an outer side of the corresponding third portion away from the optical axis, each eighth portion is arranged on an outer side of the corresponding fourth portion away from the optical axis.

3. The lens driving device as described in claim 1, wherein any adjacent first fixing part and second fixing part are arranged on the same side of the second portion and the third portion of the corresponding first elastic arm connected therebetween along the direction of the optical axis.

4. The lens driving device as described in claim 1, wherein each second fixing part is separated by a third gap into two portions.

5. The lens driving device as described in claim 1, wherein an amount of the first driving units is two, and the two first driving units are respectively arranged at two opposite corners of the optical image stabilization holder; each first driving unit comprises a magnetic circuit system fixed to the optical image stabilization holder and a focusing coil fixed to the barrel; the magnetic circuit system comprises a magnetic frame and a magnetic member disposed in the magnetic frame; the magnetic frame comprises a top wall and a bottom wall opposite to each other along the direction of the optical axis, and a side wall connecting the top wall and the bottom wall; the magnetic member is sandwiched between the top wall and the bottom wall; the focusing coil is disposed in the magnetic frame and sleeved on the magnetic member; the side wall is provided with two notches respectively arranged on two sides of the focusing coil; the barrel extends two supporting arms to the focusing coil for clamping the focusing coil; the two supporting arms respectively enter the magnetic frame through the two notches of the side wall and clamp the focusing coil.

6. The lens driving device as described in claim 5, wherein observing along the direction of the optical axis, the focusing coil and the magnetic member have a matching contour shape; the magnetic member comprises a first focusing magnet fixed to the top wall, a second focusing magnet fixed to the bottom wall, and a yoke sandwiched between the first focusing magnet and the second focusing magnet; the first focusing magnet and the second focusing magnet are magnetized in opposite directions along the direction of the optical axis.

7. The lens driving device as described in claim 1, wherein an amount of the second driving units is two, and the two second driving units are respectively arranged at another two opposite corners of the optical image stabilization holder; each second driving unit comprises a first optical image stabilization magnet fixed to the fixation holder and a first optical image stabilization coil fixed to the optical image stabilization holder; an amount of the third driving units is two, and the two third driving units are respectively arranged at the another two opposite corners of the optical image stabilization holder; each third driving unit comprises a second optical image stabilization magnet fixed to the fixation holder and a second optical image stabilization coil fixed to the optical image stabilization holder.

8. The lens driving device as described in claim 1, wherein the second elastic support comprises a first plate spring and a second plate spring respectively arranged on two opposite sides of the barrel along the direction of the optical axis.
